(19) United States
(12) Patent Application Publication
(10) Pub. No.: US 2002/0081972 A1
(43) Pub. Date: Jun. 27, 2002

(54) System control through portable devices

(75) Inventor: Paul J. Rankin, Horley (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/999,372

(22) Filed: Oct. 31, 2001

(30) Foreign Application Priority Data
Nov. 9, 2000 (GB) 0027332.6

(51) Int. Cl. H04B 5/00

(52) U.S. Cl. 455/41; 455/414; 455/455

(57) ABSTRACT

A communications system comprises at least one portable device (14) capable of wireless message transmission and at least one other device (10) capable of receiving such a message transmission. The portable device (14) is arranged to add to each message (FIG. 3) prior to transmission an additional data field carrying personal data of a user of the portable device, with the other device (10) receiving the additional data and varying at least one operational parameter (B) in response. The system allows environments or local equipment to be automatically responsive to simple, periodic, locally broadcast auras from a user's portable telephone or the like.

The present invention relates to services offered to users of electronic equipment, especially but not exclusively to users of mobile communications devices such as portable telephones and suitably equipped PDA's (personal digital assistants) and laptop computers. The invention further relates to means for use in the delivery of such services, and to devices for receiving them.

Recent years have seen a great increase in subscribers world-wide to mobile telephone networks and, through advances in technology and the addition of functionalities, cellular telephones have become personal, trusted devices. A result of this is that a mobile information society is developing, with personalised and localised services becoming increasingly more important. Such “Context-Aware” (CA) mobile telephones are used with low power, short range base stations in places like shopping malls to provide location-specific information. This information might include local maps, information on nearby shops and restaurants and so on. The user's CA terminal may be equipped to filter the information received according to pre-stored user preferences and the user is only alerted if an item of data of particular interest has been received.

An example of a CA terminal is given in U.S. Pat. No. 5,835,861 which discloses the use of wireless telephones within the context of advertisement billboards. The user of a wireless telephone obtains the telephone number of a vendor by activating his/her wireless telephone to transmit a prompt signal to an active advertisement source and to receive from the advertisement source a response signal containing the telephone number of the advertising vendor. The telephone number can then be used to automatically place a call to that vendor via the public switched telephone network. Alternatively, the telephone number can be stored for use later on. This arrangement can be used to place a call to a vendor without having to either memorise the telephone number or to write it down. The signals between the billboard and the caller can be transmitted as modulated infrared (IR) signals.

Many services and applications proposed for CA systems benefit from a genuine broadcast mode that does not require the mobile terminal to join a wireless network. The Media Lab of MIT have devised ‘meme badges’ or ‘Thinking Tags’ which allow wearers to exchange simple text messages or quotations when they are within i.r. range and in line-of-sight. Other similar concepts such as ‘hot badges’ have been published, for example by Philips Design in their 1996 ‘Vision of the Future’ (http://www.design.philips.com/vof/), where personal devices broadcast profile information about their users to the local area, to be picked up by other nearby participants for correlating personal matches. In addition, a short-range r.f. device (“the Lovegety”) became a craze for ‘blind date’ facilitation between teenagers in Japan in 1998. Users of the Lovegety could set one of three pre-assigned signals and be audibly and visually alerted when another Lovegety owner was in range, the alert being different when the encountering users have both selected the same settings (which might correspond for instance to looking for a date).

In the security field, there are many custom-designed solutions for identification, for example, smart infra-red (i.r.) or radio frequency (r.f.) keys allow access to sensitive areas or track who is present in a building. Princeton University has an electronic security system primarily designed to protect students (see New York Times, Nov. 12, 1998, E1-8, ‘Closed Door Policy’. This system uses a radio signal to carry identity information from a student's card transceiver to a card reader in proximity. This data is then fed onto a central university computer, which holds a three-week log of all student movements through dormitories, laboratories etc.

In office designs, sometimes infra-red detectors are used to sense body heat to determine whether or not people are present and so control the lighting to save power, but do not automatically sense the lighting preferences of those present.

Many services and applications proposed for CA applications benefit from a genuine broadcast mode that does not require the mobile terminal to join a wireless network. The Bluetooth specification, core version 1.0, does not inherently support this mode of operation but a possible means of adding it to the base band specification has been proposed in the commonly-assigned International patent application EP01/06948 (PHGB000084). With this mechanism, it can be foreseen that up to 64 Kbytes (gross) of broadcast information can be conveyed during the 10.24 seconds of a typical Bluetooth Inquiry phase. This information is freely available to all Bluetooth (BT) terminals capable of receiving it, whether a member of the piconet or not. For CA applications, a major application of this broadcast mode is the distribution of information keys from fixed beacons that provide links to more complete information.

Other applications have also been foreseen for connectionless broadcasting over Bluetooth, in particular its use for so-called hot badges to facilitate person-to-person exchange of personal information, as described in the commonly assigned International patent application EP 01/06941 (PHGB000110).

The goal of creating environments or devices which are automatically aware of the presence of people in proximity, anticipate their individual needs or desires and respond accordingly, adapting without explicit or conscious user control, has been one for many years. Hewlett Packard's ‘Cooltown’ scenarios, as described at http://www.cooltown.hp.com/dev, depict similar adaptive environments using i.r. or r.f. beacon technologies. Until now it has been difficult to find a cheap yet efficient way for everyone to experience such benefits which is not open to privacy invasions.

The security systems mentioned above could be used to provide information on people's locations, link into a database of their personal profiles of requirements or interests, and configure their local environment or devices in sympathy. However, unsurprisingly, such centralised tracking systems arouse considerable privacy issues. Moreover, the existence of a central database of movement records invites subpoena actions for data relevant to court cases that may be outside the original security concerns. For this reason, many establishments limit the time-span of their record keeping.

Custom i.r. or r.f. devices as used for security systems are also limited in their market penetration, while mobile phones (and, to a lesser extent, PDA's and laptops) are rapidly becoming the pervasive personal device, carried throughout the day. Bluetooth is predicted to become a common technology in such portable devices. A method for implementing the equivalent of responsive environments or ‘ambient intelligence’ which exploits commonly-available mobile phones and allows a range of privacy settings therefore has high potential.

One possible solution to connect from user to their environment might be via the full current Bluetooth v1.0b handshaking process to set up a two-way Bluetooth connection. This would allow automatic data exchange between a mobile carried by a consenting user selecting such a service and devices in the locale. This would carry the transfer from the user's mobile to the environment of identity and optional personal information. However, as discussed in the above-referenced application EP 01/06948 (PHGB000084), in the context of mobile user encounters with fixed beacons, the current Bluetooth v1.0b connection protocol carries the disadvantages of:

Time to establish the connection before any data can be exchanged (10-30secs, by which time the encountering parties may be out of r.f. range)

Power consumption for hand shaking transmissions on behalf of the listening device to establish network connection

Limits on the number of active listening devices that can be addressed by the broadcasting device (7 active in a piconet)

Loss of privacy by either the listening device or broadcasting device as its device id. becomes known by the other party in the process of establishing the network connection. For example, current developments for the Bluetooth device discovery process on a PC deliver to that PC not only the Bluetooth device id. of a discovered proprietary mobile phone, but also return that telephone owner's name. In many opportunistic situations, the user wishes their identity and location to remain anonymous and private. This exchange of short-range transceiver identifiers can therefore be a major drawback for applications where high confidence levels in identification, authentication or security of transactions are not required.

Two alternatives are possible for creating environments or devices that automatically respond in a personal fashion to the presence of people:

Direct: The device, system or environmental infrastructure tracks the presence, identity or movement of people in its proximity by sensing badges, tags or similar devices carried by people, by use of biometrics, voice prints, cameras and image analysis, or through use of other explicit manual identification technologies (fingerprint or iris recognition for example).

Indirect: People carry sensors which can use short-range networking technologies to poll nearby location beacons or carry devices which exploit other location technologies such as GPS to find out their current location. Their identity and personal information is then transmitted, possibly after transformation or other treatment by an intermediate system to hide a user's identity, back to the local responsive device, system or environment so it can adapt to the person in proximity.

The direct method raises many valid concerns regarding intrusive surveillance, where a system tracks people's movements. The indirect method is therefore preferred, but still relies on the user's trust in the confidentiality of their location and personal information being passed on, perhaps via an intermediary, to the system. For example, a transfer process using the Internet may involve installing ‘cookies’ in the user's device or web browser that may pass back to the system their device data that could identify the user or capture their activity. Technology for automatically passing user preferences to a system without accompanying data that can be traced back to the originator is uncommon. The indirect method may also suffer in the efficiency of an indirect process, e.g. delay times in passing data from mobile device to web site to local system.

It is accordingly an object of the present invention to provide a system of remote controlling or setting of devices or systems by portable devices, whilst providing enhanced security and privacy for a user.

In accordance with the present invention there is provided a communications system comprising at least one portable device capable of wireless message transmission and at least one second device capable of receiving such a message transmission, wherein the at least one portable device is arranged to broadcast a series of inquiry messages each in the form of a plurality of predetermined data fields arranged according to a first communications protocol, wherein the at least one first portable device is further arranged to add to each inquiry message prior to transmission an additional data field carrying personal data of a user of the portable device, and wherein the at least one second device is arranged to receive the transmitted inquiry messages, read data from said additional data field, and vary at least one operational parameter in response to the read data.

By controlling the operation of the second device on the basis of the personal data carried (which preferably excludes a direct identification of the users identity), an improved control is provided.

The personal data may include an alias for the user, with the at least one second device including storage means arranged to maintain a record of received personal data by reference to the alias. In such an arrangement, the at least one portable device may include user operable input means by operation of which the user may set the alias, and the at least one second device may be arranged to vary the at least one operational parameter, on detection in a received message of an alias for which a maintained record exists, at least partly in response to the personal data in said record.

Also in accordance with the present invention there is provided a mobile communication device for use as said portable device in the system described above, the device comprising communications components capable of wireless message transmission and arranged to broadcast a series of inquiry messages each in the form of a plurality of predetermined data fields arranged according to a first communications protocol, and to add to each inquiry message prior to transmission said additional data field.

Further in accordance with the present invention there is provided a communication device for use as said second device in the system described above, the device comprising a receiver capable of receiving a short-range wireless inquiry message including a plurality of data fields according to a first communications protocol, means for determining when an additional data field has been added to said plurality of data fields, and means arranged to read data from such an additional data field and vary at least one operational parameter of said communication device in response to the read data.

Yet further in accordance with the present invention there is provided a method for enabling the user of a portable communications device to broadcast control messages to other communications devices, wherein said portable communications device broadcasts a series of inquiry messages each in the form of a plurality of predetermined data fields arranged according to a first communications protocol, and wherein said first portable communications device adds to each inquiry message prior to transmission an additional data field carrying personal data of a user of the portable device, such that suitably configured other communications devices may receive the transmitted inquiry messages, read the personal data from said additional data field, and vary at least one of their operational parameters in response to such data.

Additional features of the present invention are recited in the attached claims to which reference should now be made and the disclosure of which is incorporated herein by reference.

Further features and advantages of the present invention will become apparent from reading of the following description of preferred embodiments of the present invention. given by way of example only, and with reference to the accompanying drawings, in which:

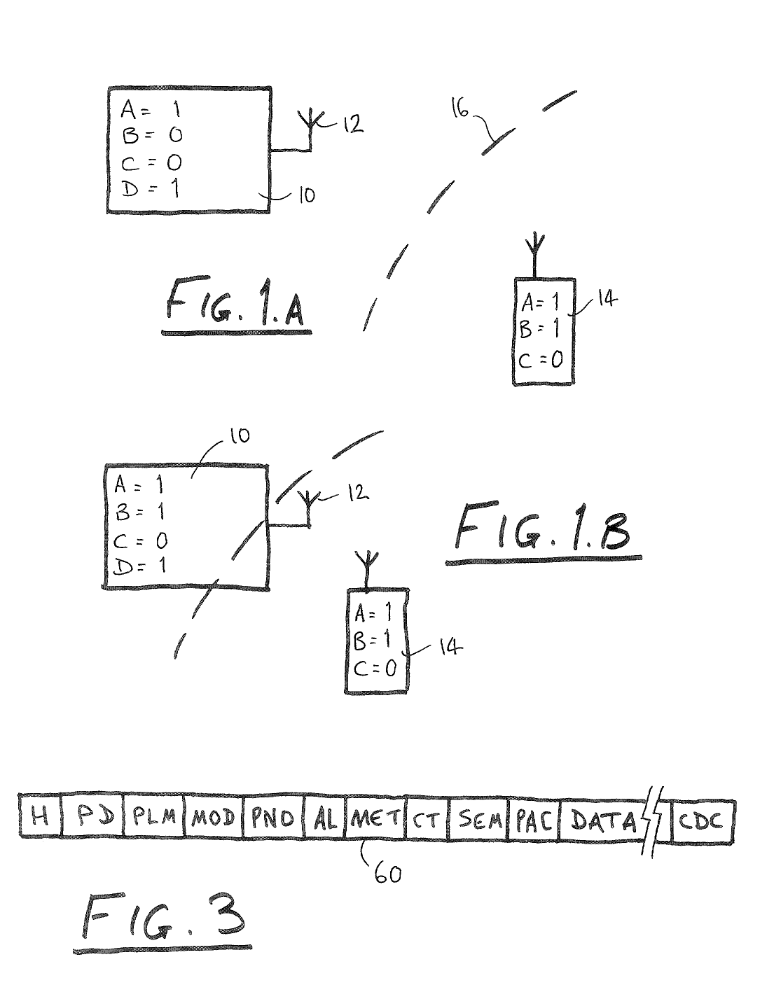

FIG. 1 shows a block schematic diagram of a system of fixed and portable devices embodying the present invention;

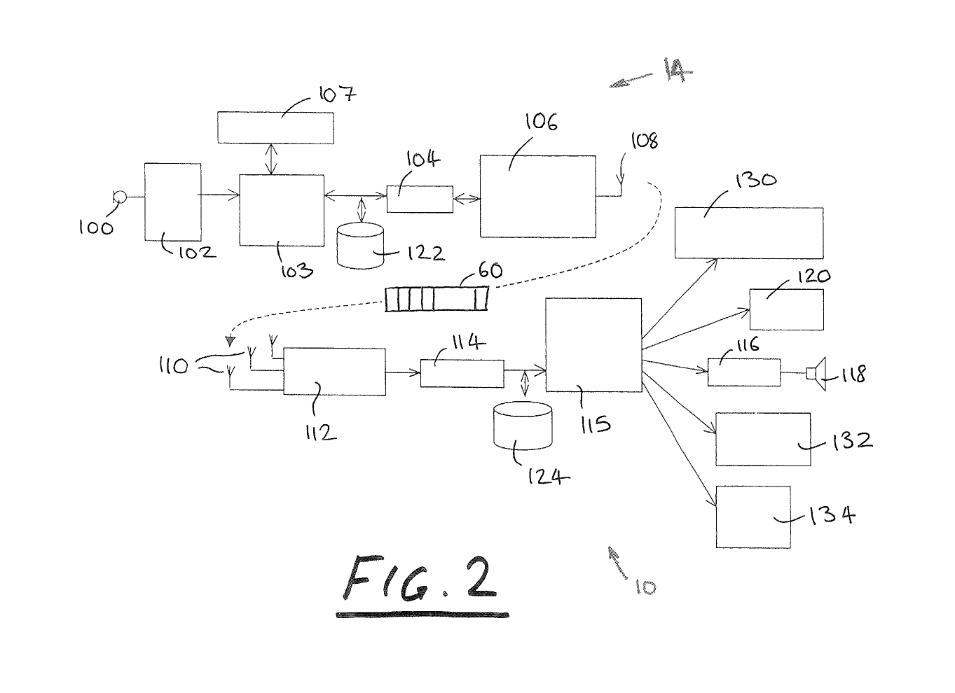

FIG. 2 is a schematic representation of data flow in an embodiment of the system of FIG. 1; and

FIG. 3 represents the contents of a transmitted data packet from the system of FIG. 1.

In the following description we consider particularly a CA application which utilises Bluetooth protocols for communication of messages from portable device (whether telephone, PDA or other) to a fixed device, or from one portable device to another. As will be recognised, the general invention concept of including a broadcast channel as part of the inquiry procedure is not restricted to Bluetooth devices, and is applicable to other communications arrangements, whether frequency hopping systems like Bluetooth, or Direct Sequence spread spectrum systems such as Lite, supporting messaging according to the Protocol for Universal Radio Links (PURL).

FIG. 1 schematically represents the operational components of the present invention, with a fixed (or at least generally static) device 10 operating with four variable parameter settings A, B, C, D at respective values 1, 0, 0, 1. Device 10 is equipped for reception of wireless messages (via aerial 12). A portable communications device 14 includes a transmitter (not shown) arranged to format messages according to a pre-determined protocol (to be described) and to broadcast them for reception by any suitably equipped receiver.

The transmission range of the portable device 14 is illustrated generally by the dashed line 16. In FIG. 1.A the fixed device 10 and portable device 14 (having preferred operational settings for a fixed device of A=1, B=1 and C=0) are too far apart for contact to be made. In FIG. 1.B, the portable device 14 has now come into reception range of the fixed device 10. The portable device 12 is continually or periodically broadcasting a message indicating its preferred operational settings, whilst not indicating its own identity. On receipt of such a message, the fixed device 10 alters the setting of parameter B from 0 to 1, as specified in the message: parameters A and C are unchanged as they are already at the setting required or requested by the portable device 14, whereas parameter D is not specified in the message from the portable device.

A preferred embodiment of the invention uses the basic ‘data broadcast over inquiry phase’ method for enhancing Bluetooth v1.0b and other communications protocols from the above-referenced commonly-assigned International patent application EP 01/06948 (PHGB000084), where the mobile devices carried by users are now the broadcasters. In the context of Bluetooth the method solves the limitations of full Bluetooth handshaking to establish a Bluetooth connection, e.g. allowing any number of listening devices in a crowded locale to quickly receive the broadcast data from a broadcasting user's mobile device. Very importantly, following the invention the ‘ID’ packets broadcast during the Bluetooth inquiry phase do not reveal the broadcaster's own Bluetooth device identity, thus preserving user's anonymity while still being able to carry useful, if non-authenticated, personal data. Of course, identifiers can, if desired, be added into the broadcast packets and so authentication done explicitly by processing the transmitted data e.g. to check a user's id. However, in many more tolerant or less critical situations, complete anonymity may be preferred. A persistent user alias, such as ‘joe’ included to track repeated presence, may often be adequate.

A gross transmission rate for broadcast over inquiry of around 64 Kbytes per cycle may be anticipated. If the mobile device performs the Inquiry cycle continuously (i.e. only broadcasts and never sets up a piconet) then a gross bit rate of 50 kbit/s results. This data rate easily allows a user to broadcast around themselves for example an XML-type profile description in a standardised format such as the W3C proposals for profile data formats (OPS, P3P), or a broadcast message, perhaps tagged by a classification type to aid filtering by different listening devices. Alternatively, as similarly described in the commonly-assigned International patent application EP01/06944 (PHGB000085) relating to audio broadcasting in inquiry phase, a musical aura or a stream of speech about the user or their interests might be broadcast locally by the user to be picked up and presented by local devices.

The listening devices 10 need to recognise that there is broadcast data in the incoming inquiry packets, extract their type (namely that this is a broadcast by a mobile user), and the information to decode the media format being broadcast. The reception of such a broadcast type of course indicates a person's presence (or at least that a mobile phone making such broadcasts is now in proximity). Such broadcasts can include a pseudo-random number (the random generator seed being reset automatically on the mobile each day) to distinguish different people, without disclosing an identifier traceable to the mobile or its owner.

Optionally, additional personal data may be broadcast which is tagged by classes, such as ‘sports interests’, ‘gender’, ‘music tastes’ or ‘computer printer preferences’ can be matched against the resource or configuration options available in the user's environment, video or audio content locally available from playback devices etc. Of course, to make this effective, common classification schemes (perhaps encoded in XML) must be agreed between the personal broadcast data and the local device or environmental settings. For example, the content selected for visual or audible presentation on a device such as a set top box (STB) or TV local to the user may be matched to their preferences and this needs an agreed content classification scheme (such as current ICE standardisation work). The same basic mechanism as described here can be used in home, entertainment, leisure, work or professional settings.

Intermittent personal broadcasts of the user's presence and preferences using data embedded in the inquiry phase can be arranged to not interfere with other Bluetooth operations, e.g. joining a piconet for secure, authenticated or higher bandwidth interactions.

The solution offered here for these ‘ambient intelligence’ applications is to extend the technique of embedding broadcast data in the inquiry phase signals from fixed Bluetooth beacons to include one-way, connectionless data broadcasts from mobile devices carried by users. The mobile device therefore creates a short-range ‘aura’ (c.f. range 16; FIG. 1) around the user which r.f. or i.r. devices in its proximity can detect.

A Bluetooth-equipped GSM or UMTS or other cellular phone is a suitable implementation platform for the mobile terminal in this application. However, there are clearly other platforms, e.g. PDA's and even laptop personal computers that are normally listed as possible mobile Bluetooth platforms.

Users can select a set of, perhaps predefined, data for local broadcast from their mobile. This data may be in the form of html-encoded device control setting commands, url's, coded graphic icons, compressed text messages, pre-recorded voice commands, lists of personal interests or desired environmental control commands in a standardised machine-readable description language and so forth. Short-range pulses of such types are then regularly broadcast from the mobile at intervals depending on the latency important for the environment and user's activity, for example every few seconds or minutes.

The listening devices, such as Bluetooth transceivers in the environment or devices in the user's proximity, need to be able to detect these Bluetooth inquiry polling signals which have been tagged as containing one-way broadcast data from mobile users. These listening devices should then have the ability to remain silent, without transmitting Bluetooth responses to the incoming inquiry signals. Incoming inquiry signals tagged as containing data packets then require decoding by the listening device to extract, decode and interpret the embedded broadcast data, for example to check how many mobiles are present, or for the arrival of a new user. Additional characteristics, or metadata (e.g. as XML descriptions) which accompany the contents of the broadcast data can be then optionally be compared against the environmental systems' own settings and options. For example, the new visitor may prefer cooler air conditioning settings.

Using the Bluetooth inquiry broadcast technique means that any number of devices within range of the r.f. broadcasts can decode the broadcast stream and respond in an adaptive manner to the presence of the user, and there is no restriction on the maximum number of devices, as might arise in a full Bluetooth network connection. In an extension, the local devices may echo in return a broadcast version of their own options (possibly modified in response to the received data), and the mobile broadcast further and more detailed preferences back automatically.

As mobiles equipped with Bluetooth will only have one radio, then they can either be broadcasting inquiry data or listening, but not both simultaneously. Moreover, if two mobiles happen to be synchronised in receiving/transmitting (e.g. by an external trigger from the environment that they both received), then it is possible for them to attempt to broadcast simultaneously. The solution to this problem is to arrange that mobiles can be put into mode of alternately broadcasting and listening, and that the start time for this cycle is pseudo-randomly chosen on each mobile.

A simplified data flow for this application is shown in FIG. 2, starting from microphone 100 of transmitting portable device 14, via activation stage 102, profile facet selection stage 103, and codec 104 to broadcasting terminal 106. From aerial 108, message 60 travels via aerial 110 to listening terminal 112 in receiving device 10. From the listening terminal 112, an audio message will travel via codec 114, interpreter and device routing stage 115, and digital to analog converter 116, to loudspeaker 118. Data messages for display will be routed from the output of codec 114 to display device 120. Other forms of message may be routed by routing stage 115 to an environmental controller 130, web browser 132, or other local device 134. At each side, a data store 122, 124 may be used to provide local storage of messages/profile data and other related information.

The interpreter and device router 115 does the work of checking for example the pseudo-random broadcaster's identity number to see whether this is a new mobile or one already present. It also decides which of many possible local devices can respond to personal preferences or pre-configuration needs, starts content selection processes, interprets broadcast personal preferences in terms of the control settings of locally-available networked devices, routes the control commands or data to equipment, devices and so forth.

The Profile Facet Selection stage 103 in the mobile process is primarily set by the user (e.g. explicitly via handset operations, or indirectly via the user's calendar or mobile portal 107). It controls what is contained in the pulsed personal broadcasts and how often those broadcasts of ‘aura’ are made. It may be set just to broadcast an alias name, for example ‘joe’, or in addition for example to broadcast the user's current news interests as automatically determined from the user's current mobile portal configuration. Provision can also be made for the user to allow the handset to sense a short-range broadcast trigger from the environment. This environmental trigger would request echoes back from any mobile devices in the neighbourhood of a certain facet (for example work interests, music tastes) from those users' personal profiles. This environmental request and mobile response interaction may be supported in duplex fashion using the method of embedding broadcast information in the Bluetooth inquiry phase.

There are many possible variations on this scheme including the activation of pre-set commands, standard messages, or text search strings for web browsers. Other arrangements are possible.

Referring back to FIG. 1, and also to FIG. 3, at the broadcasting terminal, the broadcast data has to be packetized before it is sent over the air. In the above-mentioned International patent application EP01/06948 (PHGB000084), it is shown that the proposed broadcast field can convey as much as 64 Kbytes of user information in an Inquiry cycle lasting 10.24 seconds. As described, the Inquiry messages on which we are piggybacking this data will use a CA application-specific DIAC (Dedicated Inquiry Access Code) and so receivers, CA application or otherwise, will know not to respond to the Inquiry messages in the conventional way.

A Personal Broadcast data packet 60 regularly emitted by the user's mobile might contain the following, non-exhaustive, list of fields as illustrated by FIG. 3:

| | |
|---|---|
| H = | Header |
| PD = | Protocol discriminator (or personal broadcast aura) |
| PLM = | Packet length indicator |
| MOD = | Modality (iconic, textual, musical, speech) |
| | of packet content data |
| PNO = | Pseudo-random number for discriminating between multiple |
| | users in a locale |
| AL = | Optional user alias |
| MET = | Metadata describing device control languages employed or |
| | referencing to an agreed content or preference classification |
| | schema (e.g. use of XML) |
| CT = | Codec type |
| SEM = | Start/end/middle/whole packet |
| PAC = | Packet number |
| DATA = | Main body |
| CDC = | Coded device control, content or service data. |

In an extension to the invention, any broadcast data within a predetermined locale may be picked up by a local fixed Bluetooth unit for relaying on to other fixed broadcasting units covering a larger area than the range of the personal broadcast from one mobile. This still retains privacy over a system where the users all register with a central service.

The environment or networked devices may be set to only respond to changes in the current list of local mobile presences or their broadcast preferences. The configuration of a local environment may be left by default to correspond to the preferences of the last detected personal broadcast.

Another extension might include use of a fixed ‘place identifying’ beacon to trigger broadcasts of a certain subset or facet of user data from personally-broadcasting mobile users within a specific locale. For example, a beacon in a disco might be set up to trigger personal broadcasts from any mobiles within its range of the ‘musical taste’ section of their personal data. The jukebox controller could then collate all the preferences and automatically select music that the majority of users would enjoy. In a work setting, the environment might include a fixed beacon which issues signals to cause the users' mobiles to broadcast their ‘work-resource requirements’ section of their personal data. A networked environment might then be pre-configured for these users to allow easy access to their preferred resources, to bring copiers into readiness for use from stand-by mode and so forth.

A very large range of possible applications can be created to make environments and devices easier to use. These applications do not require high security. However, the number of users, the available time to establish a full network connection, or the need to respect privacy may be prohibit full r.f network connection. A few additional examples are given to illustrate the potential scope:

TV set-top boxes automatically sense which particular household members are in the same room, pre-load trained voice-recognition parameters to enable those speakers to use voice command, and automatically switch to their favourite channels or display personally-filtered EPG displays for those present. If someone is present who is hard of hearing, captioning might be turned on automatically, or font sizes of displayed text increased for viewers with poor eyesight.

Copiers or shared office equipment may be pre-configured with the preferences of those nearby.

Background music may be shared automatically adapted to the musical preferences of those present.

A suitable persona is selected for a synthetic presenter on a STB system that matches the personality of the current user.

Music follows a user at home from room to room, without any explicit use of tokens or equipment operation.

Interactive billboards automatically animate or speak when a person with a mobile phone is close by to attract their attention. The billboards may also respond to the person's broadcast personal interest profile, but do not acquire that person's identity.

Personal screen layout and web-search preferences are automatically set-up on a user's approach to shared information systems such as PC's or information kiosks.

Air conditioning and lighting preferences are automatically set for individuals entering a room. Power-saving measures are also possible: devices, heating, lighting etc might be put in stand-by mode when no one is present in a room (as is also done by. i.r. detectors).

Popular paths through a town are determined by counting the number of different personal broadcasts sensed at fixed points for urban planning purposes.

Gymnasium equipment is automatically set to correspond to a nearby user's exercise programme.

An in-car transceiver triggers an automatic personal broadcast from the driver's mobile of their alias (for checking against broadcasts from passengers) and sets their radio channel preferences. Driver's seat settings are adjusted.

Displays and announcements in airport lounges highlight information on flights relevant to those waiting whom are broadcasting their travel schedules.

Conversations in a room are recorded, automatically tagged by the speakers' data broadcast of aliases and time-keyed passwords. These conversations can be replayed at a later time, but only by the same people.

Discos automatically play the most popular selections for the majority of people present.

There are other short-range networking technologies that may be able to emulate one-way broadcasting, with or without disclosure of a device id. As will be recognised, this invention may be realisable via irDA, Home RF Lite ZigBee, PURL (Protocol for Universal RadioLinks) or even using a custom r.f. device capable of simple fixed-frequency broadcasting.

From reading the present disclosure, other modifications will be apparent to persons skilled in the art. Such modifications may involve other features which are already known in the design, manufacture and use of fixed and portable communications systems, and systems and components for incorporation therein and which may be used instead of or in addition to features already described herein.

1. A communications system comprising at least one portable device capable of wireless message transmission and at least one second device capable of receiving such a message transmission, wherein the at least one portable device is arranged to broadcast a series of inquiry messages each in the form of a plurality of predetermined data fields arranged according to a first communications protocol, wherein the at least one first portable device is further arranged to add to each inquiry message prior to transmission an additional data field carrying personal data of a user of the portable device, and wherein the at least one second device is arranged to receive the transmitted inquiry messages, read data from said additional data field, and vary at least one operational parameter in response to the read data.

2. A system as claimed in claim 1, wherein the personal data carried excludes a direct identification of the users identity.

3. A system as claimed in claim 1, wherein the personal data includes an alias for the user, and the at least one second device includes storage means arranged to maintain a record of received personal data by reference to the alias.

4. A system as claimed in claim 3, wherein the at least one portable device includes user operable input means by operation of which the user may set the alias.

5. A system as claimed in claim 3, wherein the at least one second device is arranged to vary said at least one operational parameter, on detection in a received message of an alias for which a maintained record exists, at least partly in response to the personal data in said record.

6. A system as claimed in claim 1, wherein the at least one portable device is arranged to add said additional data field at the end of a respective inquiry message.

7. A system as claimed in claim 1, wherein the at least one portable device is arranged to include an indication in one of said predetermined data fields, said indication denoting the presence of said additional data field.

8. A system as claimed in claim 1, wherein said first communications protocol comprises Bluetooth messaging.

9. A system as claimed in claim 1, wherein the at least one portable device further comprises means for generating said personal data of a user from user profiling of said user of said portable device.

10. A mobile communication device for use as said portable device in the system of claim 1, the device comprising communications components capable of wireless message transmission and arranged to broadcast a series of inquiry messages each in the form of a plurality of predetermined data fields arranged according to a first communications protocol, and to add to each inquiry message prior to transmission said additional data field.

11. A communication device for use as said second device in the system of claim 1, the device comprising a receiver capable of receiving a short-range wireless inquiry message including a plurality of data fields according to a first communications protocol, means for determining when an additional data field has been added to said plurality of data fields, and means arranged to read data from such an additional data field and vary at least one operational parameter of said communication device in response to the read data.

12. A device as claimed in claim 11, wherein the receiver is configured to receive messages according to Bluetooth protocols.

13. A method for enabling the user of a portable communications device to broadcast control messages to other communications devices, wherein said portable communications device broadcasts a series of inquiry messages each in the form of a plurality of predetermined data fields arranged according to a first communications protocol, and wherein said first portable communications device adds to each inquiry message prior to transmission an additional data field carrying personal data of a user of the portable device, such that suitably configured other communications devices may receive the transmitted inquiry messages, read the personal data from said additional data field, and vary at least one of their operational parameters in response to such data.
